(19) United States
(12) Patent Application Publication
(10) Pub. No.: US 2022/0044337 A1
(43) Pub. Date: Feb. 10, 2022

(54) MANAGEMENT DEVICE, MANAGEMENT SYSTEM, AND MANAGEMENT METHOD

(71) Applicant: HONDA MOTOR CO., LTD., Tokyo (JP)

(72) Inventors: Naokatsu Sato, Tokyo (JP); Yoshitaka Mimura, Wako-shi (JP); Koji Kawabe, Wako-shi (JP); Masahide Kobayashi, Tokyo (JP)

(21) Appl. No.: 17/393,441

(22) Filed: Aug. 4, 2021

(30) Foreign Application Priority Data
Aug. 7, 2020 (JP) 2020-134710

(51) Int. Cl. G06Q 50/12; G01C 21/34; G05D 1/02

(52) U.S. Cl. CPC G06Q 50/12; G06Q 2240/00; G05D 1/0276; G01C 21/3492

(57) ABSTRACT

A management device that is configured to manage a robot device, the management device comprising: a memory configured to store instructions; and one or more processors configured to execute the instructions to: acquire identification information for identifying the user and time information on a time at which a vehicle having a user therein is scheduled to arrive at an arrival point, wherein the arrival point is point at which the vehicle is scheduled to arrive and the user is scheduled to exit; and provide the robot device with instruction information including the identification information for causing the robot device to guide the user from the arrival point to a destination of the user on the basis of the acquired time information and the acquired identification information.

### CROSS-REFERENCE TO RELATED APPLICATION

Priority is claimed on Japanese Patent Application No. 2020-134710, filed Aug. 7, 2020, the content of which is incorporated herein by reference.

### BACKGROUND

### Field

The present invention relates to a management device, a management system, and a management method.

### Description of Related Art

In the related art, an automatic parking system including an automatic parking control device that controls automatic parking of a vehicle having an automated driving function and a mobile terminal that can communicate with the automatic parking control device is known (for example, see Patent Document 1). In such an automatic parking system, when a result of retrieval of an available parking area is received from the automatic parking control device, the mobile terminal transmits an instruction for selection of a parking area to the automatic parking control device on the basis of a user's operation. The automatic parking control device selects a target parking area out of available parking areas on the basis of the instruction received from the mobile terminal and causes the vehicle to park automatically in the target parking area (PCT International Publication No. WO2017/168754).

### SUMMARY

However, in the aforementioned system, convenience for a user of a vehicle may be low. For example, an occupant may have difficulty moving to a destination after exiting the vehicle.

The invention was made in consideration of the aforementioned circumstances and an objective thereof is to provide a management device, a management system, and a management method that can improve convenience for a user of a vehicle.

A management device, a management system, and a management method, and a storage medium according to the invention employ the following configurations.

(1) A management device according to an aspect of the invention is a management device that is configured to manage a robot device, the management device comprising: a memory configured to store instructions; and one or more processors configured to execute the instructions to: acquire identification information for identifying the user and time information on a time at which a vehicle having a user therein is scheduled to arrive at an arrival point, wherein the arrival point is point at which the vehicle is scheduled to arrive and the user is scheduled to exit; and provide the robot device with instruction information including the identification information for causing the robot device to guide the user from the arrival point to a destination of the user on the basis of the acquired time information and the acquired identification information.

(2) In the aspect of (1), the destination may be located at a position which is in a predetermined facility and which the vehicle is not able to reach from the arrival point.

(3) In the aspect of (1) or (2), the identification information may be an image which is obtained by imaging the user or feature information indicating a feature which is extracted from the image.

(4) In any one of the aspects of (1) to (3), the instruction information may include an instruction for causing the robot device to wait at a set point which is set in advance at the arrival point or in a facility associated with the arrival point and the scheduled arrival time and to guide the user to the destination after the user has arrived at the arrival point.

(5) In any one of the aspects of (1) to (4), the robot device may wait at a set point which is set in advance in a facility associated with the arrival point, and the instructions further comprise instructions to provide a terminal device correlated with the user with information indicating a route from the arrival point to the set point.

(6) In any one of the aspects of (1) to (5), the instructions further comprise instructions to: provide a terminal device correlated with the user with information indicating a route from the arrival point to a set point which is set in advance in a facility associated with the arrival point and at which the robot device waits when a distance from the arrival point to the set point is equal to or greater than a predetermined distance.

(7) In any one of the aspects of (1) to (6), the instructions further comprise instructions to: determine whether the user has used a facility including the destination in the past with reference to information indicating whether the user has used the facility and determine a mode for inquiring of the user about whether to request the robot device guide the user to the destination via the vehicle or a terminal device carried by the user on the basis of the result of determination.

(8) In any one of the aspects of (1) to (7), the instructions further comprise instructions to: determine a route along which the robot device guides the user on the basis of positions of a plurality of destinations which are included in a predetermined facility or degrees of congestion of the destinations when the destination of the user includes the plurality of destinations.

(9) In any one of the aspects of (1) to (7), the instructions further comprise instructions to: determine a route along which the robot device guides the user on the basis of positions of a plurality of destinations which are included in a predetermined facility and degrees of congestion of the destinations when the destination of the user includes the plurality of destinations.

(10) A management system according to another aspect of the invention includes: the management device according to any one of the aspects of (1) to (9); and a robot device that is configured to guide the user to the destination on the basis of the instruction information provided by the management device.

(11) A management system according to another aspect of the invention includes: the management device according to any one of the aspects of (1) to (9); and a vehicle which the user boards, and the management device is configured to acquire the time information and the identification information from the vehicle.

(12) The management system according to the aspect of (11) may further include a robot device that is configured to guide the user to the destination on the basis of the instruction information provided by the management device.

(13) A management device according to another aspect of the invention is a management device that is configured to manage a robot device, the management device comprising: a memory configured to store instructions; and one or more processors configured to execute the instructions to: acquire identification information for identifying the user and time information on a time at which a vehicle having a user therein is scheduled to arrive at an arrival point, wherein the arrival point is point at which the vehicle is scheduled to arrive and the user is scheduled to exit; and provide the terminal device correlated with the user with a route from the arrival point to a point at which the robot device waits on the basis of the acquired time information and the acquired identification information and provide the robot device with instruction information including the identification information for causing the robot device to guide the user from the point at which the robot device waits to a destination of the user.

(14) A management method according to another aspect of the invention is a management method of managing a robot device, which is performed by a computer, the management method comprising: acquiring identification information for identifying the user and time information on a time at which a vehicle having a user therein is scheduled to arrive at an arrival point at which the vehicle is scheduled to arrive and the user is scheduled to exit; and providing the robot device with instruction information including the identification information for causing the robot device to guide the user from the arrival point to a destination of the user on the basis of the acquired time information and the acquired identification information.

(15) A non-transitory computer-readable storage medium according to another aspect of the invention is a non-transitory computer-readable storage medium causing a computer to: manage a robot device, the medium causing a computer to perform: acquire time information on a time at which a vehicle having a user therein is scheduled to arrive at an arrival point at which the vehicle is scheduled to arrive and the user is scheduled to exit and identification information for identifying the user; and provide the robot device with instruction information including the identification information to cause the robot device to guide the user from the arrival point to a destination of the user on the basis of the acquired time information and the acquired identification information.

According to the aspects of (1) to (15), since the management device is configured to provide the robot device with the instruction information including identification information to cause the robot device to guide a user from the arrival point to the destination of the user, it is possible to improve convenience for the user.

According to the aspects of (5) and (6), since the management device is configured to provide the terminal device with information indicating a route from the arrival point to the point at which the robot device waits, a user can easily reach the point at which the robot device waits.

According to the aspect of (7), since the management device is configured to determine the mode for inquiring of the user in consideration of whether the user has visited the destination or a facility including the destination in the past, the user can appropriately determine the necessity of guidance.

According to the aspect of (8) or (9), since the management device is configured to determine a route that a user is guided by the robot device on the basis of the position or the degree of congestion of a destination, the user can comfortably use the destination.

### BRIEF DESCRIPTION OF THE DRAWINGS

FIG. 1 is a diagram showing an example of a configuration of a management system including a management device.

FIG. 2 is a diagram showing a configuration of a vehicle system.

FIG. 3 is a diagram showing an example of a functional configuration of a management device.

FIG. 4 is a diagram showing an example of a functional configuration of a robot device.

FIG. 5 is a (first) diagram showing a service that is provided to an occupant of a vehicle.

FIG. 6 is a (second) diagram showing a service that is provided to an occupant of a vehicle.

FIG. 7 is a diagram showing an example of a situation in which an occupant having exited a vehicle is guided by a robot device.

FIG. 8 is a diagram showing an example of information that is displayed at a point (A).

FIG. 9 is a diagram showing an example of information that is displayed at a point (B).

FIG. 10 is a diagram showing an example of information that is displayed at a point (C).

FIG. 11 is a sequence diagram showing an example of a flow of processes that are performed by a management system.

FIG. 12 is a (first) diagram showing information processing in the sequence diagram shown in FIG. 11.

FIG. 13 is a (second) diagram showing information processing in the sequence diagram shown in FIG. 11.

FIG. 14 is a flowchart showing an example of a flow of processes that are performed by the management device.

FIG. 15 is a diagram showing an example of an image IM that is displayed on a display of a terminal device according to a second embodiment.

FIG. 16 is a sequence diagram showing an example of a flow of processes that are performed by the management system.

FIG. 17 is a diagram showing an example of a situation in which a robot device guides a user when the user visits a plurality of destinations.

FIG. 18 is a diagram showing an example of congestion information.

FIG. 19 is a sequence diagram showing an example of a flow of processes that are performed by the management device and a plurality of robot devices.

FIG. 20 is a diagram showing an example of a schedule that is created by the management device.

### DETAILED DESCRIPTION

Hereinafter, embodiments of a management device, a management system, a management method, and a storage medium according to the invention will be described with reference to the accompanying drawings.

### First Embodiment

[Overall Configuration]

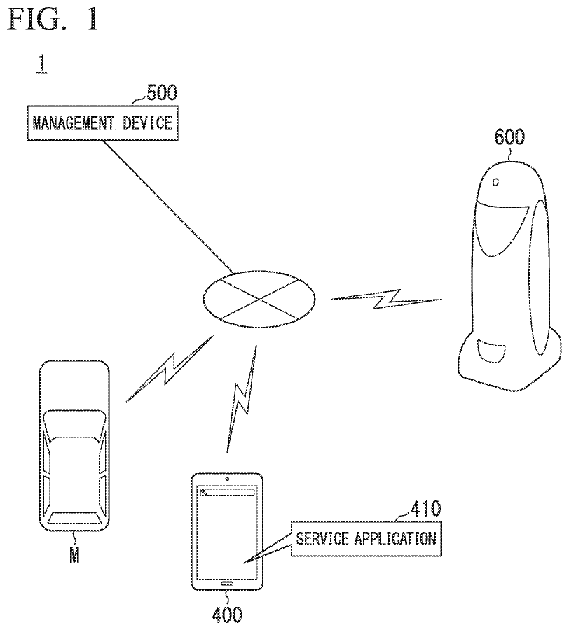

FIG. 1 is a diagram showing an example of a configuration of a management system 1 including a management device. The management system 1 includes, for example, a vehicle M, a terminal device 400, a management device 500, and a robot device 600. These elements communicate with each other via a network NW. The network NW includes the Internet, a wide area network (WAN), a local area network (LAN), a public circuit line, a provider device, a dedicate circuit line, or a radio base station.

[Vehicle]

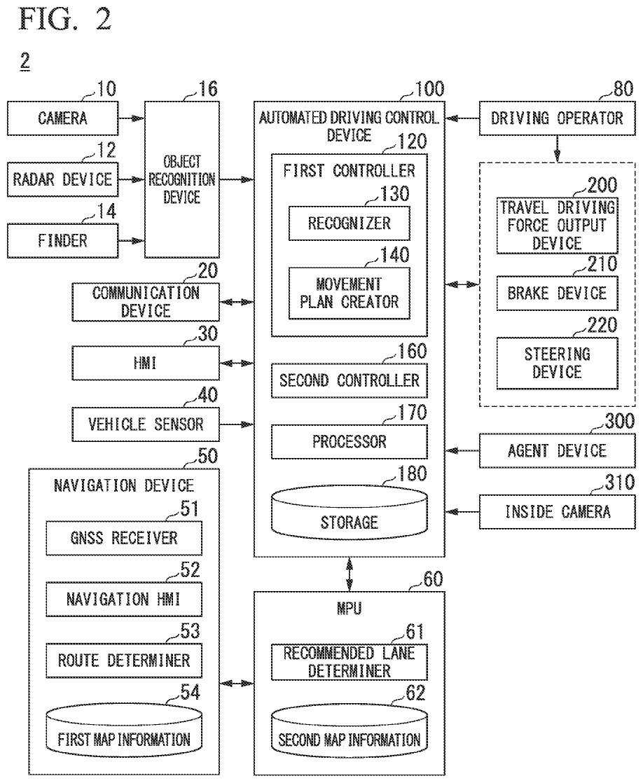

FIG. 2 is a diagram showing a configuration of a vehicle system 2. A vehicle in which the vehicle system 2 is mounted is, for example, a vehicle with two wheels, three wheels, or four wheels and a drive source thereof is an internal combustion engine such as a diesel engine or a gasoline engine, an electric motor, or a combination thereof. An electric motor operates using electric power which is generated by a power generator connected to the internal combustion engine or electric power which is discharged from a secondary battery or a fuel cell.

The vehicle system 2 includes, for example, a camera 10, a radar device 12, a finder 14, an object recognition device 16, a communication device 20, a human-machine interface (HMI) 30, a vehicle sensor 40, a navigation device 50, a map positioning unit (MPU) 60, a driving operator 80, an automated driving control device 100, a travel driving force output device 200, a brake device 210, a steering device 220, an agent device 300, and an inside camera 310. These devices or instruments are connected to each other via a multiplex communication line such as a controller area network (CAN) communication line, a serial communication line, a radio communication network, or the like. The configuration shown in FIG. 1 is only an example and a part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on a vehicle (hereinafter, referred to as a vehicle M) in which the vehicle system 2 is mounted. The radar device 12 radiates radio waves such as millimeter waves to the surroundings of the vehicle M, detects radio waves (reflected waves) reflected by an object, and determines at least the position (the distance and the direction) of the object. The finder 14 is a Light Detection and Ranging device (LIDAR). The finder 14 applies light to the surroundings of the vehicle M and measures scattered light. The finder 14 determines the distance to an object on the basis of a time from radiation of light to reception of light.

The object recognition device 16 performs a sensor fusion process on results of detection from some or all of the camera 10, the radar device 12, and the finder 14 and recognizes a position, a type, a speed, and the like of an object. The object recognition device 16 outputs the result of recognition to the automated driving control device 100.

The communication device 20 communicates with other vehicles near the vehicle M, for example, using the network NW, Bluetooth (registered trademark), or dedicated short range communication (DSRC) or communicates with various server devices via a radio base station.

The HMI 30 presents various types of information to an occupant of the vehicle M and receives an input operation from the occupant. The HMI 30 includes various display devices, speakers, buzzers, a touch panel, switches, and keys.

The vehicle sensor 40 includes a vehicle speed sensor that determines a speed of the vehicle M, an acceleration sensor that determines acceleration, a yaw rate sensor that determines the angular velocity around a vertical axis, and a direction sensor that determines a direction of the vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies the position of the vehicle M on the basis of signals received from GNSS satellites. The navigation HMI 52 includes a display device, a speaker, a touch panel, and keys. The navigation HMI 52 may be partially or entirely shared by the HMI 30. For example, the route determiner 53 determines a route (hereinafter referred to as a route on a map) from the position of the vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides a route on a map supplied from the navigation device 50 into a plurality of blocks (for example, every 100 [m] in a vehicle travel direction) and determines a recommended lane for each block with reference to the second map information 62. The recommended lane determiner 61 determines in which lane from the leftmost the vehicle is to travel.

The second map information 62 is map information with higher precision than the first map information 54. The second map information 62 includes, for example, information on the centers of lanes or information on boundaries of lanes. The second map information 62 may include road information, traffic regulation information, address information (addresses and postal codes), facility information, and phone number information. The second map information 62 may be updated from time to time by causing the communication device 20 to communicate with another device.

The driving operator 80 includes, for example, an accelerator pedal, a brake pedal, a shift lever, a steering wheel, a deformed steering wheel, a joystick, and various other operators. A sensor that determines the amount of operation or performing of an operation is attached to the driving operator 80, and results of detection thereof are output to the automated driving control device 100 or some or all of the travel driving force output device 200, the brake device 210, and the steering device 220.

The automated driving control device 100 includes, for example, a first controller 120, a second controller 160, and a processor 170. The first controller 120, the second controller 160, and the processor 170 are realized, for example, by causing a hardware processor such as a central processor (CPU) to execute a program (software). Some or all of such elements may be realized by hardware (which includes circuitry) such as a large scale integration (LSI), an application specific integrated circuit (ASIC), a field-programmable gate array (FPGA), or a graphics processor (GPU) or may be realized by software and hardware in cooperation. The program may be stored in a storage device (a storage device including a non-transitory storage medium) such as an HDD or a flash memory of the automated driving control device 100 in advance, or may be stored in a removable storage medium such as a DVD or a CD-ROM and be installed in the HDD or the flash memory of the automated driving control device 100 by inserting the storage medium (the non-transitory storage medium) into a drive device.

The first controller 120 includes, for example, a recognizer 130 and a movement plan creator 140. The first controller 120 performs a function based on artificial intelligence (AI) and a function based on a predetermined model together. For example, a function of “recognizing a crossing” may be embodied by performing recognition of a crossing based on deep learning or the like and recognition based on predetermined conditions (such as signals and road signs which can be pattern-matched), scoring both recognitions, and comprehensively evaluating both recognitions. Accordingly, reliability of automated driving is secured.

The recognizer 130 recognizes states such as a position, a speed, and an acceleration of an object near the vehicle M on the basis of information input via the object recognition device 16. For example, a position of an object is recognized as a position in an absolute coordinate system with an origin set to a representative point of the vehicle M (such as the center of gravity or the center of a drive shaft) and is used for control. The “state” of an object may include an acceleration or a jerk of the object or a “moving state” (for example, whether lane change is being performed or whether a lane change is going to be performed) thereof.

The movement plan creator 140 creates a target trajectory in which the vehicle M will travel autonomously (without requiring a driver's operation) in the future such that the vehicle M travels in a recommended lane determined by the recommended lane determiner 61 in principle and copes with surrounding circumstances of the vehicle M. A target trajectory includes, for example, a speed element. For example, a target trajectory is expressed by sequentially arranging points (trajectory points) at which the vehicle M is to arrive. Trajectory points are points at which the vehicle M is to arrive at intervals of a predetermined traveling distance (for example, about several [m]) along a road, and a target speed and a target acceleration at intervals of a predetermined sampling time (for example, about below the decimal point [sec]) are created as a part of a target trajectory in addition.

The movement plan creator 140 may set events of automated driving in creating a target trajectory. The events of automated driving include a constant-speed travel event, a low-speed following travel event, a lane change event, a branching event, a merging event, a take-over event, and an automatic parking event. The movement plan creator 140 creates a target trajectory based on events which are started.

The automatic parking event is an event in which the vehicle M parks automatically at a predetermined parking position without requiring an occupant's operation. The predetermined parking position may be a parking position which is designated by a parking lot management device which is not shown or may be an available parking position (an empty parking position) which is recognized by the vehicle M. The vehicle M may perform the automatic parking event in cooperation with the parking lot management device or the terminal device 400. For example, the vehicle M moves in a designated direction or parks in a designated position on the basis of an instruction which is transmitted by the parking lot management device. The vehicle M may perform the automatic parking event on the basis of the instruction of the terminal device 400 after an occupant has exited.

The second controller 160 controls the travel driving force output device 200, the brake device 210, and the steering device 220 such that the vehicle M travels along a target trajectory created by the movement plan creator 140 as scheduled.

The second controller 160 acquires information of a target trajectory (trajectory points) created by the movement plan creator 140 and stores the acquired information in a memory (not shown). The second controller 160 controls the travel driving force output device 200 or the brake device 210 on the basis of speed elements accessory to the target trajectory stored in the memory. The second controller 160 controls the steering device 220 on the basis of a curve state of the target trajectory stored in the memory.

The processor 170 generates information which is transmitted to the management device 500 or sets a destination of the vehicle M in cooperation with the agent device 300. The processor 170 analyzes an image captured by the inside camera 310. Details of the process which is performed by the processor 170 will be described later.

The travel driving force output device 200 outputs a travel driving force (a torque) for allowing the vehicle to travel to the driving wheels. The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of information input from the second controller 160 or information input from the driving operator 80 such that a brake torque based on a braking operation is output to vehicle wheels. The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the driving operator 80 to change the direction of the turning wheels.

The agent device 300 makes conversation with an occupant of the vehicle M or provides a service to the occupant. Examples of the service include provision of information and reservation for use of a facility of a destination (for example, reservation for a seat in a restaurant). The agent device 300 recognizes speech from an occupant, selects information which is provided to the occupant on the basis of the result of recognition, and outputs the selected information to the HMI 30. Some or all of these functions may be realized by artificial intelligence technology. The agent device 300 may make conversation with the occupant or provide a service thereto in cooperation with an agent server device which is not shown via the network NW.

The agent device 300 performs processes, for example, by causing a hardware processor such as a CPU to execute a program (software). Some or all of elements of the agent device 300 may be realized by hardware (which includes circuitry) such as an LSI, an ASIC, an FPGA, or a GPU or may be realized by software and hardware in cooperation. The program may be stored in a storage device (a storage device including a non-transitory storage medium) such as an HDD or a flash memory in advance, or may be stored in a removable storage medium (the non-transitory storage medium) such as a DVD or a CD-ROM and be installed i by inserting the storage medium into a drive device. The inside camera 310 is a camera that is provided inside the vehicle M and mainly captures an image of a user's face.

[Terminal Device]

The terminal device 400 is, for example, a smartphone or a tablet terminal. The terminal device 400 is, for example, a terminal device that is carried by an occupant (a user) of the vehicle M. In the terminal device 400, an application program, a browser, or the like for use of a service which is provided by the management system 1 is started to support services which will be described below. In the following description, it is assumed that the terminal device 400 is a smartphone and an application program for receiving a service (a service application 410) is started. The service application 410 communicates with the management device 500, provides information to a user, or provides information based on a user's operation of the terminal device 400 to the management device 500 or the terminal device 400.

[Management Device]

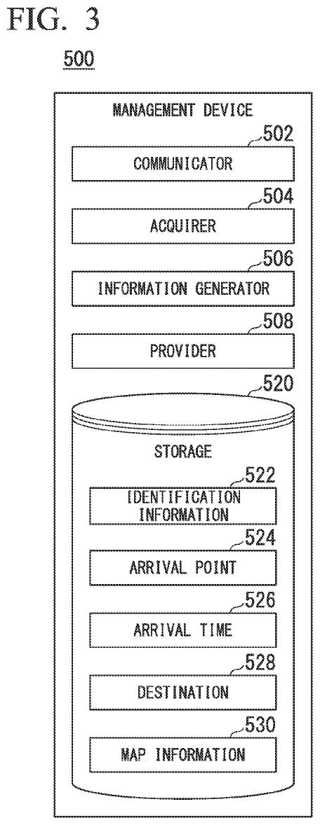

FIG. 3 is a diagram showing an example of a functional configuration of the management device 500. The management device 500 includes, for example, a communicator 502, an acquirer 504, an information generator 506, a provider 508, and a storage 520. The functional configuration of the provider 508 or a combination of the information generator 506 and the provider 508 is an example of a “provider.”

The communicator 502 is, for example, a radio communication module that accesses the network NW or communicates directly with another terminal device.

Some or all of the acquirer 504, the information generator 506, and the provider 508 are realized, for example, by causing a hardware processor such as a CPU to execute a program (software). Some or all of these elements may be realized by hardware (which includes circuitry) such as an LSI, an ASIC, an FPGA, or a GPU or may be realized by software and hardware in cooperation. The program may be stored in a storage device (a storage device including a non-transitory storage medium) such as an HDD or a flash memory of the management device 500 in advance, or may be stored in a removable storage medium such as a DVD or a CD-ROM and be installed in the HDD or the flash memory of the management device 500 by inserting the storage medium (the non-transitory storage medium) into a drive device. The storage 520 is realized, for example, by an HDD, a flash memory, an electrically erasable programmable read only memory (EEPROM), a read only memory (ROM), or a random access memory (RAM).

For example, the storage 520 stores identification information 522, an arrival point 524, an arrival time 526, a destination 528, and map information 530. Some information thereof may be omitted. The identification information 522, the arrival point 524, the arrival time 526 (an example of “time information”), and the destination 528 are information which is provided to the vehicle M. The map information 530 is map information in a predetermined facility (a facility which is visited by a user (a facility which may be visited by the user)).

The identification information 522 is information for identifying a user. The identification information 522 is, for example, an image which is obtained by imaging a user or feature information indicating a feature of the user which is extracted from the image. The arrival point 524 is information on a point at which the vehicle M arrives. The arrival time 526 is information on an arrival time at which the vehicle M arrives at the arrival point. The destination 528 is a destination which is scheduled to be visited by the user. Feature information is, for example, a luminance distribution or a luminance gradient distribution.

The acquirer 504 acquires information which is provided by the vehicle M. The acquired information is stored in the storage 520.

The information generator 506 generates instruction information on the basis of the information (for example, the arrival time 526 and the identification information 522) acquired by the acquirer 504. The instruction information is an instruction for causing a robot device to guide a user from an arrival point at which the vehicle M having the user therein is scheduled to arrive and the user is scheduled to exit (or a set point which is preset) to the destination of the user. The instruction information includes the identification information 522 for identifying the user, the arrival point 524 at which the vehicle M arrives, the arrival time 526 at which the vehicle M arrives at the arrival point, the destination 528 of the user, and a waiting point of the robot device 600. The arrival point 524, the arrival time 526, the destination 528, or the waiting point may be omitted. For example, the destination 528 may be a preset place in a facility (for example, a front desk of a hotel or a place which a user visiting a facility first drops by). The arrival point 524 or the waiting point may be a position which is set in advance in this way.

When the waiting point at which the robot device 600 waits is included in the instruction information, the information generator 506 may determine the waiting point on the basis of the map information 530 and the arrival point. The waiting point is, for example, an arrival point, an entrance, a porch, or vicinities thereof. The instruction information may include a time at which the robot device 600 waits at the waiting point.

The provider 508 provides the generated instruction information to the robot device 600.

[Robot Device]

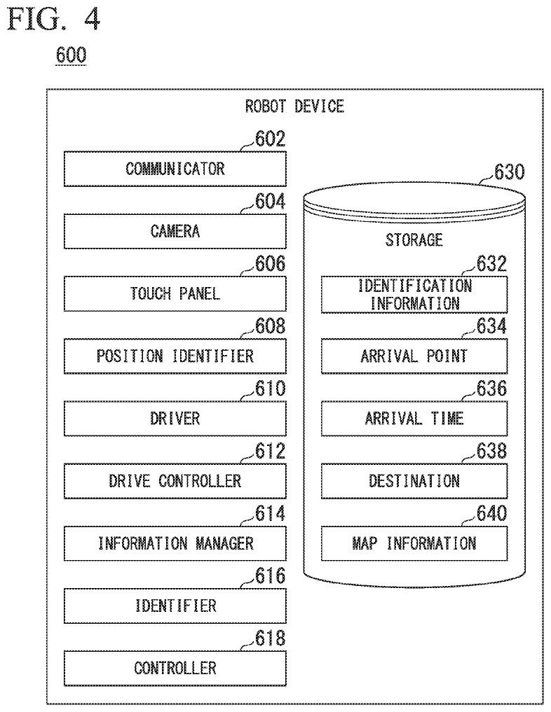

FIG. 4 is a diagram showing an example of a functional configuration of the robot device 600. The robot device 600 includes, for example, a communicator 602, a camera 604, a touch panel 606, a position identifier 608, a driver 610, a drive controller 612, an information manager 614, an identifier 616, a controller 618, and a storage 630. Some or all of the drive controller 612, the information manager 614, the identifier 616, and the controller 618 are realized, for example, by causing a hardware processor such as a CPU to execute a program (software). Some or all of these elements may be realized by hardware (which includes circuitry) such as an LSI, an ASIC, an FPGA, or a GPU or may be realized by software and hardware in cooperation. The program may be stored in a storage device (a storage device including a non-transitory storage medium) such as an HDD or a flash memory of the robot device 600 in advance, or may be stored in a removable storage medium such as a DVD or a CD-ROM and installed in the HDD or the flash memory of the robot device 600 by inserting the storage medium (the non-transitory storage medium) into a drive device. The storage 630 is realized, for example, by an HDD, a flash memory, an EEPROM, a ROM, or a RAM.

Information which is provided from the management device 500 is stored in the storage 630. For example, the identification information 632, the arrival point 634, the arrival time 636, the destination 638, and the map information 640 are stored in the storage 630. The map information 640 is map information of a facility which is controlled by the robot device 600. The identification information 632, the arrival point 634, the arrival time 636, and the destination 638 are the same information as the identification information 522, the arrival point 524, the arrival time 526, and the destination 528 described above. Some of the information may be omitted. Information on a waiting point which is provided by the management device 500 may be stored in the storage 630 and the waiting point may be determined in advance. The arrival point 524 may be the waiting point.

The communicator 602 is, for example, a radio communication module that accesses the network NW or communicates directly with another terminal device. The communicator 602 performs radio communication on the basis of a communication standard such as DSRC or Bluetooth.

The camera 604 is, for example, a digital camera using a solid-state imaging device such as a CCD or a CMOS. The camera 604 is attached to an arbitrary position on the robot device 600. The camera 604 is attached to a position at which a person near the robot device 600 can be imaged.

The touch panel 606 is a device in which a display device and an input device are combined. A user selects information or inputs information by performing a touch operation, a swipe operation, or the like on an image displayed on the display device.

The position identifier 608 measures its own position, for example, on the basis of radio waves transmitted from GNSS satellites (for example, GPS satellites).

The driver 610 includes, for example, a drive source such as a motor or a transmission mechanism that transmits power which is generated by driving the drive source. A travel part (for example, wheels) is activated by power transmitted by the driver 610 such that robot device 600 travels. For example, when the drive source is a motor, the robot device 600 includes a battery that supplies electric power to the motor. The drive controller 612 controls the drive source such as a motor. The robot device 600 may be a bipedal robot.

The information manager 614 manages information acquired from the management device 500. For example, the information manager 614 acquires information transmitted from the management device 500 and stores the acquired information in the storage 630.

The identifier 616 identifies a user who is to be guided by the robot device 600 using information managed by the information manager 614. The identifier 616 identifies a user to be guided on the basis of the identification information 632 and an image captured by the camera 604. When information indicating a feature of a person included in the image captured by the camera 604 coincides with feature information included in instruction information or feature information acquired from the image, the identifier 616 identifies the person imaged by the camera 604 as the user to be guided. Coincidence is not limited to perfect coincidence and may include coincidence to a predetermined extent or more.

The controller 618 controls the robot device 600 such that it guides a user to be guided to a destination on the basis of the instruction information. The controller 618 causes the robot device 600 to wait at a predetermined point or causes the robot device 600 to move to the destination while guiding the user. The waiting point is a set point which is designated by the management device 500 or a set point which is set in advance (an entrance, a porch, a vicinity thereof, an arrival point, or a waiting point). The controller 618 displays information on a display of the touch panel 606 or outputs speech from a speaker which is not shown.

[Service that is Provided to Occupant of Vehicle (User)]

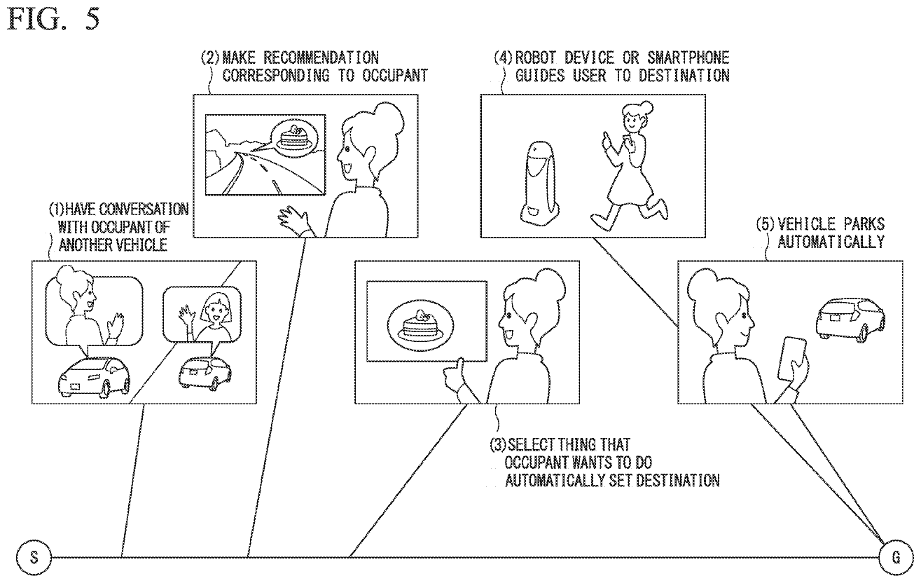

FIG. 5 is a (first) diagram showing a service that is provided to an occupant of a vehicle M. For example, it is assumed that the vehicle M departs from a start point (S) and travels by automated driving.

(1) After the vehicle M has departed, the occupant can converse with an occupant of another vehicle via the HMI 30. In this case, the vehicle M and the other vehicle may communicate with each other directly or via the network NW.

(2) The agent device 300 of the vehicle M makes a recommendation corresponding to the occupant. For example, the agent device 300 identifies the occupant or categories of the occupant (such as sex, age, and taste) and makes a recommendation to the occupant on the basis of the result of identification. Accordingly, the agent device 300 can provide information in which the occupant is interested. For example, the agent device 300 provides the occupant with information such as “How about a meal in a restaurant with good window scenery?” or “How about a roller coaster in an amusement park?”

(3) When the occupant selects something that she or he wants to do on the basis of the recommended information, the vehicle M sets a place in which the thing that the occupant wants to do can be realized as a destination. For example, when the occupant wants to have a meal in Restaurant A, the vehicle M sets Restaurant A (or a facility in which Restaurant A is provided) as a destination. Then, the vehicle M travels to the destination by automated driving.

(4) When the vehicle M arrives at the destination (G), one or both of the robot device 600 and the terminal device 400 (a smartphone) guide the occupant of the vehicle M to the destination. (5) The vehicle M performs an automatic parking event to park at a parking position automatically after the occupant exits.

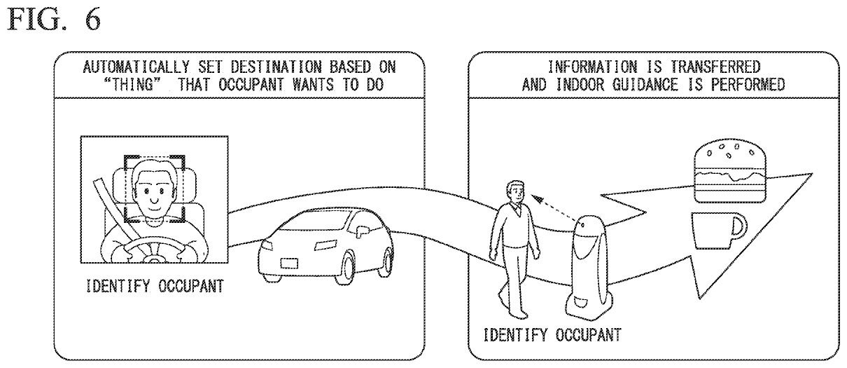

FIG. 6 is a (second) diagram showing a service that is provided to an occupant of a vehicle M. As described above, the vehicle M identifies an occupant and determines a destination of the vehicle M from things that the occupant wants to do. Information or the like determined in the vehicle M is transferred to the robot device 600 via the management device 500. Then, the robot device 600 identifies a target user (a person who has exited) and guides the user to the destination indoors such as in a facility.

In this way, since the vehicle M provides various services to an occupant, the occupant's convenience is improved. As described above, the vehicle M which is a movement means and an activity in the destination can be smoothly linked and seamless movement can be realized. A user can move to a destination smoothly or have a feeling of safety even in a strange place after exiting the vehicle M.

[Guidance in Facility]

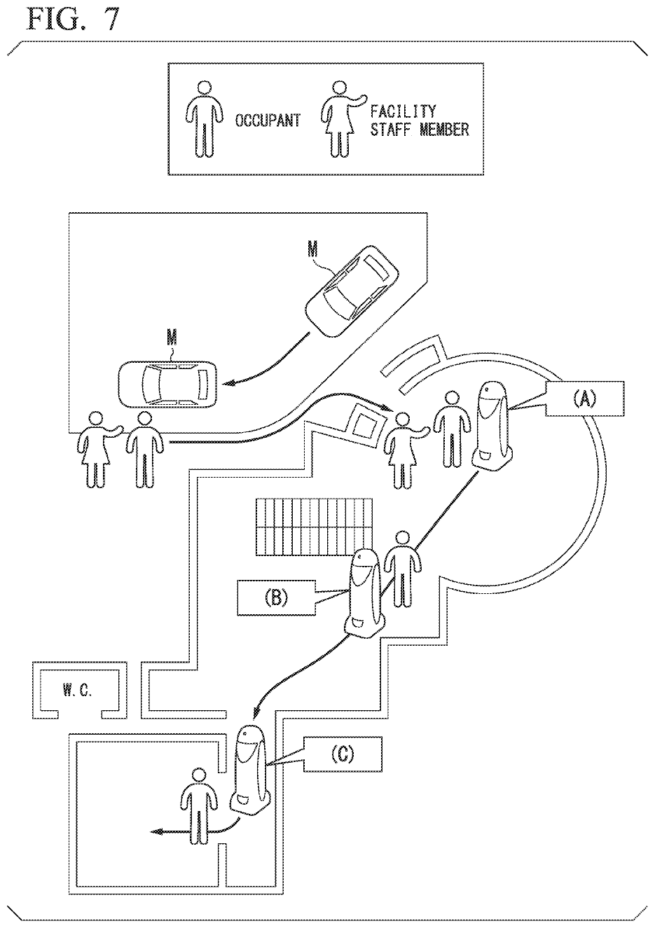

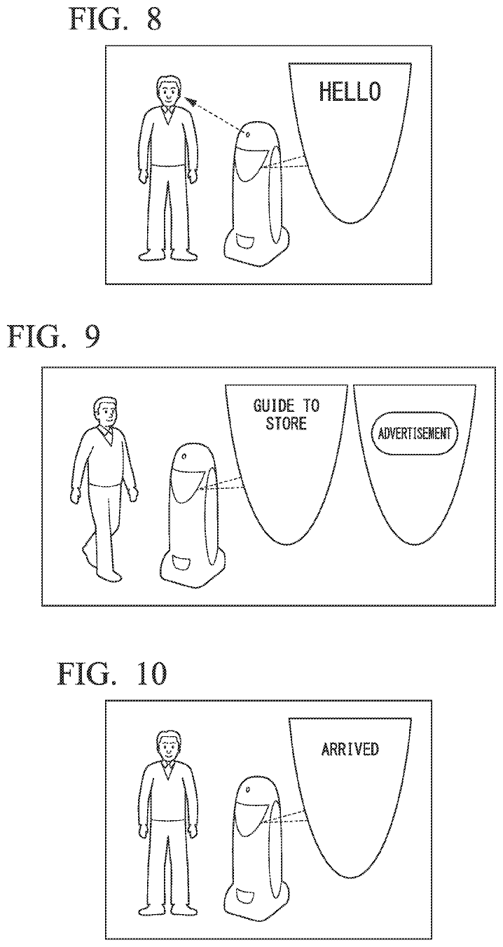

FIG. 7 is a diagram showing an example of a situation in which an occupant who has exited a vehicle M is guided by a robot device 600. When the vehicle M stops at a porch of a facility and the occupant exits, a facility staff member guides the user (the occupant) to a point at which the robot device 600 waits. Then, the robot device 600 recognizes the user and guides the user to a destination when the recognized user is a user to be guided. When the user is guided, information is provided to the user depending on progress via a display of the robot device 600. Information which is provided at Points (A) to (C) in FIG. 7 will be described later with reference to FIGS. 8 to 10 which will be described later.

In the aforementioned example, a guidance staff member guides the user to the point at which the robot device 600 waits, but the invention is not limited thereto and the robot device 600 may wait on the porch or the point at which the robot device 600 waits may be displayed on a display of the terminal device 400.

As described above, since an occupant who exits the vehicle M is guided to a destination by the robot device 600, it is possible to improve convenience for the user (occupant). For example, even when a destination is located at a position which cannot be reached from the arrival point by the vehicle M or a position which is a predetermined distance from the arrival point as shown in FIG. 7, the user can move to the destination without getting lost under the guidance of the robot device 600.

FIG. 8 is a diagram showing an example of information which is displayed at Point (A). Point (A) is a point at which the robot device 600 waits. For example, the robot device 600 recognizes a user and notifies the user that a user to be guided has been recognized when the recognized user is the user to be guided. In the example shown in FIG. 8, the robot device 600 displays information indicating “HELLO” on the display after recognizing the user to be guided. The robot device 600 may output speech instead of (or in addition to) displaying the information.

FIG. 9 is a diagram showing an example of information which is displayed at Point (B). Point (B) is a point between Point (A) and the destination. At Point (B), the robot device 600 is guiding the user to the destination. At this time, the robot device 600 displays information indicating guidance to the destination, an advertisement, or the like on the display thereof. The advertisement includes information such as introduction of a facility, stores included in the facility, or services which are provided by the facility.

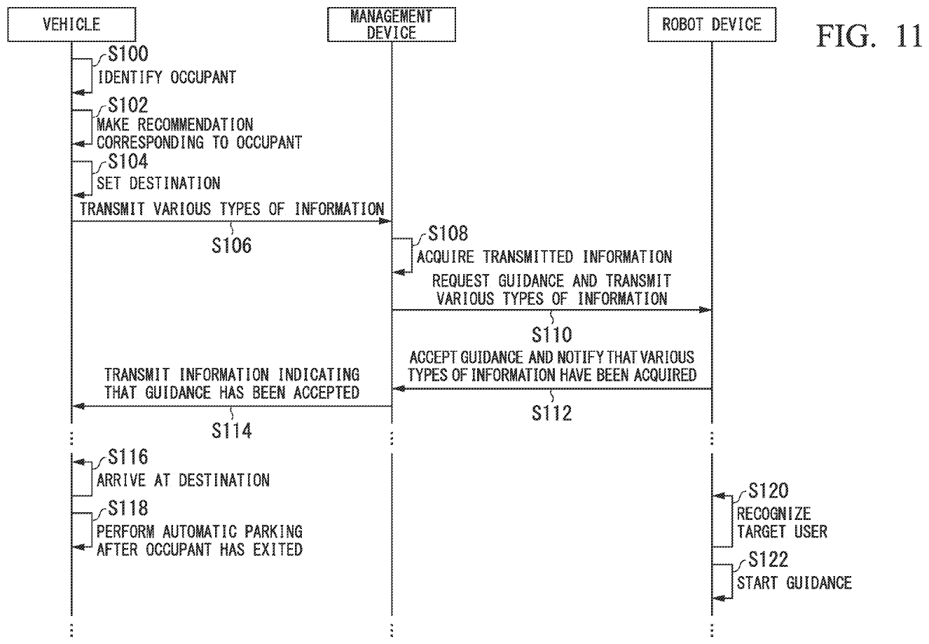

FIG. 10 is a diagram showing an example of information which is displayed at Point (C). Point (C) is a point in the vicinity of a store which is the destination. At Point (C), the robot device 600 displays information indicating arrival at the destination on the display.

As described above, the robot device 600 provides the user with information based on the progress of the guidance for the user. Accordingly, it is possible to improve a user's feeling of safety or the user's convenience. Since advertisements of the facility or the like are provided to the user, the user can move to the destination without getting bored or acquire useful information. The user can easily use the facility through the advertisements, which is useful to a manager of the facility.

[Sequence Diagram]

FIG. 11 is a sequence diagram showing an example of a flow of processes which are performed by the management system 1. First, the vehicle M identifies an occupant (Step S100) and makes a recommendation corresponding to the identified occupant (Step S102). Then, the vehicle M sets a destination of the vehicle M on the basis of an activity selected by the occupant (something that the occupant wants to do) (Step S104).

Then, the vehicle M transmits various types of information to the management device 500 (Step S106). The various types of information include, for example, the identification information 522, the arrival point 524, the arrival time 526, and the destination 528. Some of such information may be omitted. For example, the arrival point 524 or the arrival time 526 may be omitted.

Then, the management device 500 acquires various types of information transmitted in Step S106 (Step S108). Then, the management device 500 identifies a facility in which an activity is performed and a robot device 600 which waits in the facility on the basis of the acquired information and transmits a request for guidance and various types of information to the identified robot device 600 (Step S110). For example, information in which a facility and a robot device 600 which waits in the facility are correlated with each other is stored in the storage 630 of the management device 500. The management device 500 identifies the robot device 600 with reference to the information stored in the storage 630. When a device that manages a robot device 600 is provided for each facility, the management device 500 transmits the request for guidance and various types of information to the device that manages the robot device 600 of the facility.

Then, the robot device 600 transmits information indicating that the request for guidance has been accepted and various types of information have been acquired to the management device 500 (Step S112). Then, when the information transmitted in Step S112 is acquired, the management device 500 transmits information indicating that guidance for the vehicle M has been accepted (Step S114). Accordingly, information indicating that the robot device 600 guides the user to the destination is output to the HMI 30 of the vehicle M after the user has exited the vehicle.

Then, after the vehicle M arrives at the destination (Step S116) and an occupant exits the vehicle M, the vehicle M moves automatically to a parking position of a parking lot and parks at the parking position (Step S118). For example, the vehicle M may move automatically to the parking lot when the occupant has made a predetermined motion, or may move automatically to the parking lot when the robot device 600 has started guidance.

The predetermined motion is a predetermined operation of the terminal device 400 or a predetermined gesture. The vehicle M performs an automatic parking event when information indicating that the predetermined operation has been performed is acquired from the terminal device 400 or when it is recognized that the predetermined gesture has been made. The vehicle M may perform the automatic parking event when information indicating that the robot device 600 has started guidance or information indicating that the robot device 600 has recognized that the occupant is a user to be guided is acquired from the robot device 600 or the management device 500.

After the automatic parking event has been started, the robot device 600 may start guidance. In this case, the vehicle M and the robot device 600 communicate with each other directly or via the management device 500, and the robot device 600 acquires information indicating that the automatic parking event has been started from the vehicle M. In this way, since the robot device 600 starts guidance after the automatic parking event has been started, it is possible to prevent the vehicle M from being left in a state in which the vehicle is stopped at the arrival point and to more reliably cause the vehicle M to park at a predetermined parking position.

Then, when a user to be guided is recognized (Step S120), the robot device 600 guides the user to the destination (Step S122).

Since a user can move to a destination seamlessly as described above, it is possible to improve the user's convenience.

[Information Processing (First Part)]

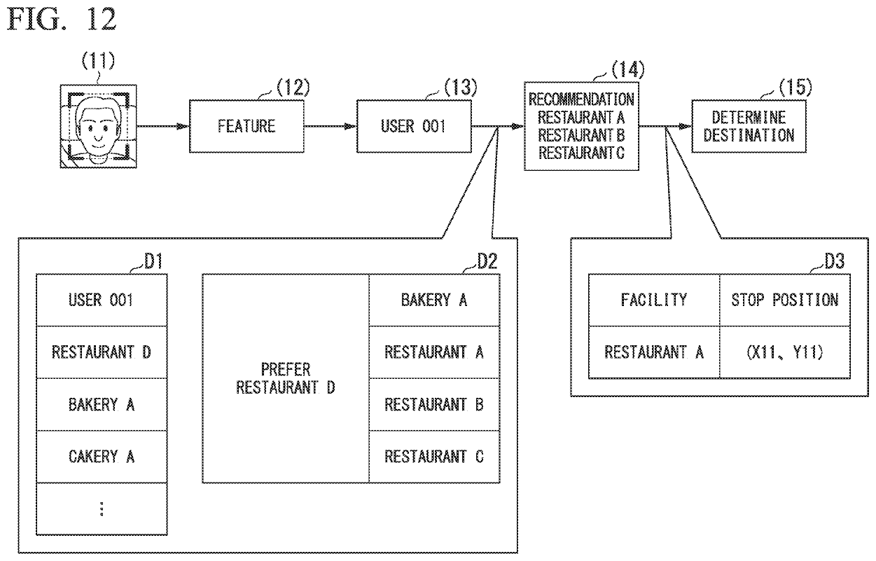

FIG. 12 is a (first) diagram showing information processing in the sequence diagram shown in FIG. 11. Information processing in the vehicle M will be described below with reference to FIG. 12. (11) First, the processor 170 of the vehicle M acquires an image of a user in the vehicle M, and (12) acquires feature information from the acquired image. (13) Then, the processor 170 identifies a user correlated with the feature information coinciding with (12) with reference to information in which feature information and identification information of a user are correlated and which is stored in advance in the storage 180 of the vehicle M.

(14) Then, the processor 170 is configured to acquire information which is to be recommended to the user with reference to behavior history information D1 of the user and recommendation information D2 which are stored in the storage 180. The behavior history information D1 is information indicating places that the user has visited in the past (for example, a facility or an activity). The recommendation information D2 is information indicating a place which a user who has visited a predetermined place is estimated to be interested in (for example, a facility or an activity).

(15) When the user selects a destination (or an activity) from the recommended information, the processor 170 identifies a position of the selected destination with reference to position information D3. Then, the processor 170 acquires the feature information of the user, the position of the destination, and a scheduled arrival time at the destination.

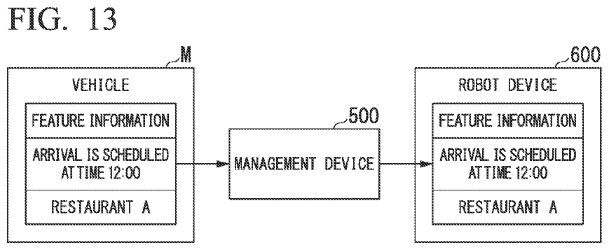

FIG. 13 is a (second) diagram showing information processing in the sequence diagram shown in FIG. 11. Information which is handled by the management device 500 will be described below with reference to FIG. 13. The management device 500 acquires the feature information of the user, the position of the destination, and the scheduled arrival time at the destination from the vehicle M. Then, the management device 500 generates instruction information on the basis of the acquired information and provides the generated instruction information to the robot device 600. The robot device 600 identifies the user using the acquired feature information of the user when the user approaches the robot device 600, and guides the user to the destination when it is determined that the user is a user to be guided.

In this way, the management device 500 can seamlessly guide a user to a destination by instructing the robot device 600 on the basis of information acquired from the vehicle M.

In the aforementioned example, the identification information 632 is an image or feature information, but a predetermined password, information on a fingerprint, or the like may be used instead (or in addition). In this case, the robot device 600 may recognize the user to be guided by allowing a user to operate the touch panel 606 of the robot device 600 or to touch a predetermined sensor with a finger.

[Others]

As will be described below, the management device 500 determines whether a user has used a facility including a destination with reference to information indicating whether the user has used the facility in the past, and determines a mode for inquiry of the user about whether to request the robot device 600 to guide the user to the destination via the vehicle M or the terminal device 400 which is carried by the user according to the result of determination. That is, the management device 500 changes the mode for inquiry according to the result of determination.

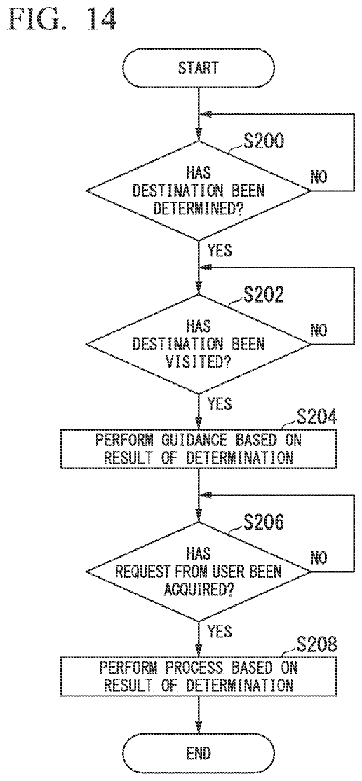

FIG. 14 is a flowchart showing an example of a flow of processes which are performed by the management device 500. The routine in this flowchart is performed, for example, after the management device 500 has acquired various types of information (after Step S108) in the sequence diagram shown in FIG. 11. First, the management device 500 determines whether the destination of the user has been determined (Step S200). When the destination has been determined, the management device 500 determines whether the user has visited the destination (Step S202). For example, information in which a user and positions visited by the user are correlated is stored in the storage 630 of the management device 500.

Then, the management device 500 provides information based on the result of determination of Step S202 to the user (Step S204). Providing information to a user means that information is provided to the vehicle M that the user is in or that is provided with information to the terminal device 400 correlated with the user.

For example, when the user has visited the determined destination (or a facility including the destination) in the past, the management device 500 provides information indicating that the user has visited the destination in the past and information on an inquiry about whether guidance by the robot device 600 is desired to the user. For example, when the user has not visited the determined destination (or the facility including the destination) in the past, the management device 500 provides information indicating that the user has not visited the destination in the past and information on an inquiry about whether guidance by the robot device 600 is desired to the user. Only the information on an inquiry about whether guidance by the robot device 600 is desired may be provided to the user.

Then, the management device 500 determines whether a request from the user has been acquired (Step S206) and performs processing based on the result of determination (Step S208). For example, the management device 500 instructs the robot device 600 to perform guidance when the user desires guidance from the robot device 600, and does not instruct the robot device 600 to perform guidance when the user does not desire guidance from the robot device 600. The management device 500 may inquire of the user about whether a route from the arrival point to the destination (or a route to a place in which the robot device 600 waits) is to be displayed by the terminal device 400, and determine whether to provide information indicating the route to the terminal device 400 according to a response to the inquiry (see a second embodiment which will be described later). Accordingly, the routine of the flowchart ends.

As described above, the management device 500 provides information on a past behavior history of the user to the user. Accordingly, the user can determine whether guidance by the robot device 600 is necessary and receive a service of guidance by the robot device 600 according to the necessity. As a result, it is possible to further improve the user's convenience.

According to the aforementioned first embodiment, since the management device 500 provides instruction information including identification information such that a user is guided from an arrival point to a destination of the user by a robot device 600 on the basis of time information and identification information to the robot device 600, it is possible to improve a user's convenience.

### Second Embodiment

A second embodiment will be described below. In the first embodiment, a facility staff member guides a user to a waiting point at which a robot device 600 waits after the user in a vehicle M has exited. In the second embodiment, information indicating a route from the exit point to the waiting point is displayed on the display of a terminal device 400 correlated with the user. The second embodiment will be described below.

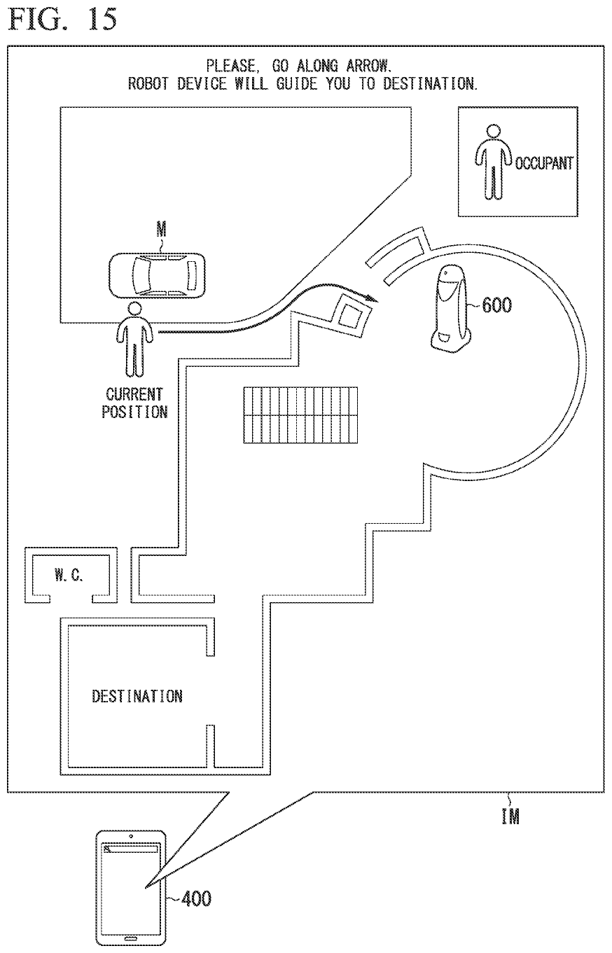

FIG. 15 is a diagram showing an example of an image IM which is displayed on the display of the terminal device 400 according to the second embodiment. For example, the image IM includes information indicating a route from the position of the terminal device 400 (the position of the user) to the waiting point.

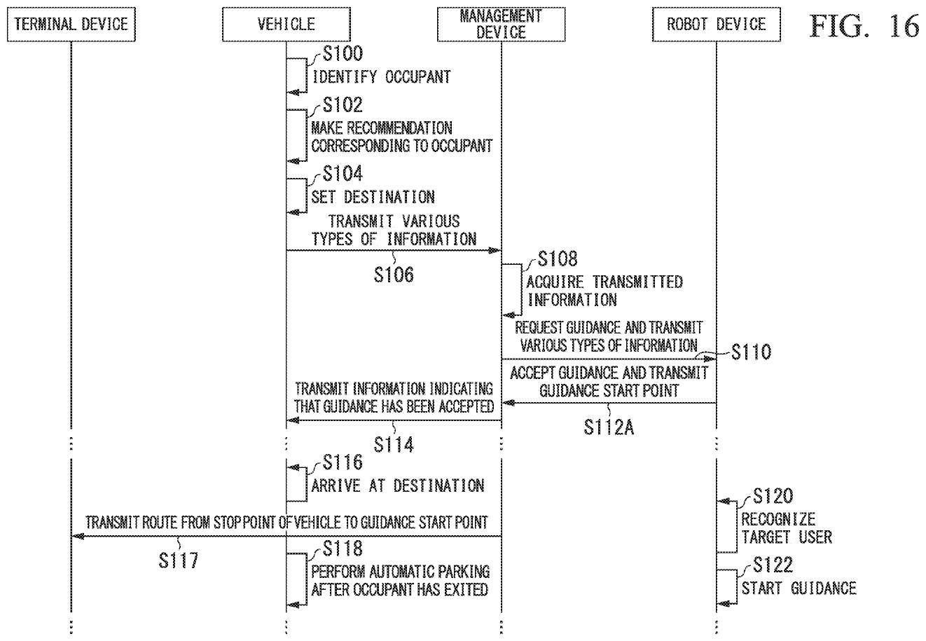

FIG. 16 is a sequence diagram showing an example of a flow of processes which are performed by the management system 1. Processes which are common to the processes shown in FIG. 11 according to the first embodiment will not be described below.

After the processes of Steps S100 to S110 have been performed, the robot device 600 transmits information indicating that guidance has been accepted and a guidance start point to the management device 500 (Step S112A). The guidance start point may be stored in the storage 520 of the management device 500, and the management device 500 may identify the guidance start point. The guidance start point is an example of a “set point.”

Then, the management device 500 transmits information indicating that guidance has been accepted to the vehicle M (Step S114). After the vehicle M has arrived at the destination (Step S116), the management device 500 transmits a route from a stop point of the vehicle to the guidance start point to the terminal device 400 (Step S117). Accordingly, the terminal device 400 displays information indicating the route on the display. The process of Step S117 may be performed at an arbitrary timing such as before Step S116 or after Step S118 which will be described later. After the process of Step S117 has been performed, the processes of Steps S118 to S122 are performed.

Since the route to the guidance start point is displayed on the terminal device 400 as described above, it is possible to improve a user's convenience. For example, even when the guidance start point is a predetermined distance or more from the point at which the user in the vehicle M has exited, the user can easily arrive at the guidance start point with reference to the route displayed on the display of the terminal device 400.

Providing information indicating the route to the guidance start point may be performed when the guidance start point is a predetermined distance or more from the point at which the user in the vehicle M has exited or may be performed in response to a request from the user.

According to the aforementioned second embodiment, since the management device 500 provides a route from an arrival point to a point at which a robot device 600 waits to a terminal device 400 correlated with a user and provides instruction information including identification information such that the user is guided from the point at which the robot device 600 waits to a destination of the user by the robot device 600 to the robot device 600, it is possible to further improve a user's convenience.

### Third Embodiment

A third embodiment will be described below. In the first embodiment, it has been assumed that a user visits one destination. In the third embodiment, it is assumed that a user visits a plurality of destinations. The third embodiment will be described below.

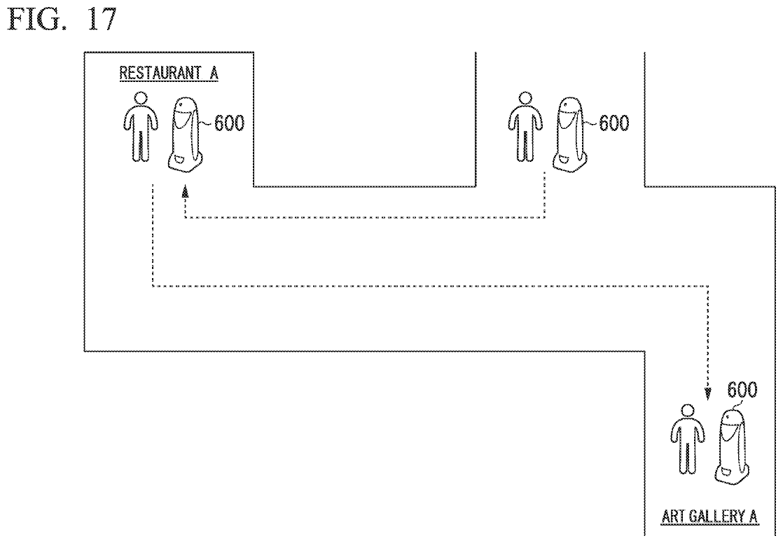

For example, it is assumed that a user selects visiting of a plurality of destinations in a vehicle M. For example, it is assumed that the plurality of destinations are located in one facility. FIG. 17 is a diagram showing an example of a situation in which a user is guided by a robot device 600 when the user visits a plurality of destinations. For example, it is assumed that a user selects visiting of Restaurant A and Art Gallery A which are included in a predetermined facility. In this case, the management device 500 generates a guidance plan for causing a robot device 600 to guide a user on the basis of the user's desire or a degree of congestion of a destination which will be described later. For example, as shown in FIG. 17, the guidance plan is a plan for guiding the user to Restaurant A and then guiding the user to Art Gallery A. The robot device 600 that guides the user from the guidance start point to Restaurant A and the robot device 600 that guides the user from Restaurant A to Art Gallery A may be different robot devices 600 or may be the same robot device 600.

The management device 500 may generate the guidance plan on the basis of the position of the facility instead of (in addition to) the degree of congestion. For example, the management device 500 may generate the guidance plan such that a moving distance of the user decreases. For example, when the degree of congestion is constant, the guidance plan is generated such that the moving distance decreases.

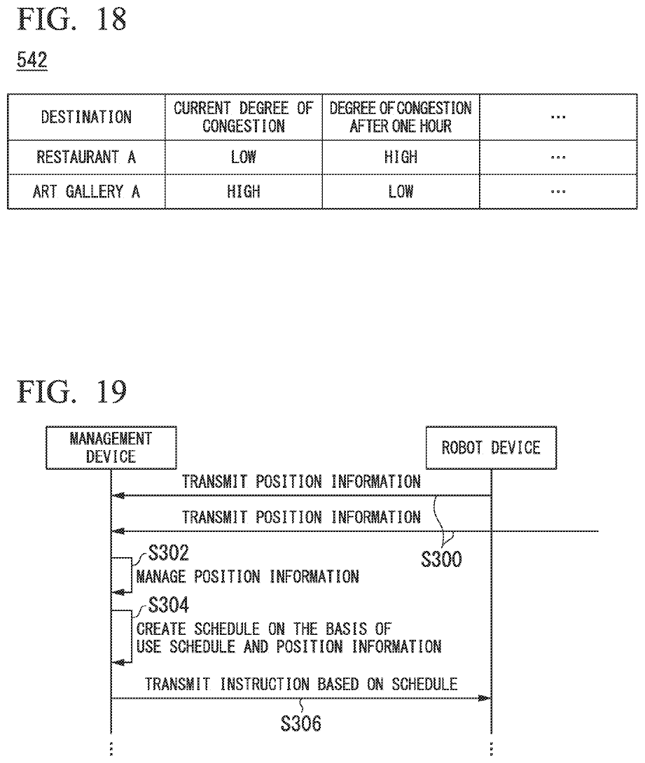

An example in which the management device 500 generates a guidance plan on the basis of a degree of congestion of a destination has been described above. The management device 500 generates a guidance plan, for example, with reference to congestion information 542. FIG. 18 is a diagram showing an example of the congestion information 542. The congestion information 542 is, for example, information which is provided from another server device. The congestion information 542 includes information indicating a current degree of congestion and a predicted future degree of congestion of the destination.

For example, as shown in FIG. 18, when it is assumed that the current degree of congestion of Restaurant A is low, the future degree of congestion thereof is high, the current degree of congestion of Art Gallery A is high, the future degree of congestion thereof is low, and a vehicle M arrives at the facility after several minutes, the management device 500 may propose the user to have a meal in Restaurant A and then to visit Art Gallery A and may generate a guidance plan based on this schedule.

When the user desires visiting of Art Gallery A and does not desire visiting of other destinations and Art Gallery A is congested, for example, the management device 500 may provide information indicating that Art Gallery A is currently congested and the congestion is relaxed after one hour to the user and propose visiting of Restaurant A to the user because Restaurant A is not congested. After the robot device 600 has started guidance of the user, the management device 500 may regenerate or update the guidance plan and provide information based on the guidance plan to the user or perform such proposal via the agent device 300 of the vehicle M.

In this way, since the management device 500 creates a guidance plan on the basis of a degree of congestion, a user can avoid congestion and more efficiently experience an activity.

The management device 500 may manage schedules of one or more robot devices 600 such that the one or more robot devices 600 operate efficiently. FIG. 19 is a sequence diagram showing an example of a flow of processes which are performed by the management device 500 and a plurality of robot devices 600. The management device 500 communicates with a robot device 600 at predetermined intervals and acquires position information of the robot device 600 (Step S300). Then, the management device 500 stores the position information of the robot device 600 in the storage 630 and manages the information (Step S302). Then, the management device 500 creates a schedule for the robot device 600 on the basis of a request for use of the robot device 600 and the position information (Step S304). Then, the management device 500 transmits an instruction to the robot device 600 on the basis of the created schedule (Step S306).

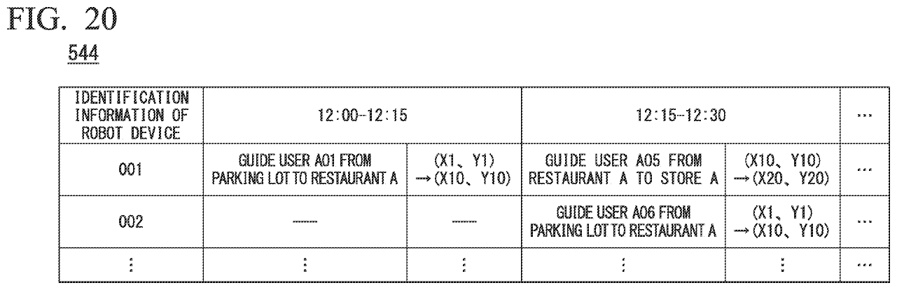

FIG. 20 is a diagram showing an example of a schedule 544 which is created by the management device 500. The schedule 544 is, for example, information in which identification information of a robot device 600, a time period, and information on a position to which the robot device 600 moves in the time period are correlated with each other. For example, the management device 500 creates a schedule of the robot device 600 such that the robot device 600 can efficiently guide a user. For example, the management device 500 guides a user to Restaurant A and then guides another user who moves from Restaurant A to Store A to Store A.

Since the management device 500 creates a schedule such that a robot device 600 operates efficiently as described above, it is possible to curb an increase in cost of a manager of the robot device 600 and to provide a service to more users.

According to the aforementioned third embodiment, since the management device 500 determines a route along which a user is guided on the basis of positions of destinations or degrees of congestion thereof, it is possible to support the user's comfortable visiting of a plurality of destinations.

In the aforementioned example, the vehicle M is driven by automated driving, but may be driven by manual driving. In this case, a user drives the vehicle to an arrival point on the basis of guidance by the navigation device 50. Instead of the vehicle M, the terminal device 400 may have the function of the agent device 300 or the function of determining a destination.

A part or whole of the functional configuration of the management device 500 may be provided, for example, in another device such as the vehicle M, the terminal device 400, and the robot device 600.

While embodiments of the invention have been described above, the invention is not limited to the embodiments and can be subjected to various modifications and substitutions without departing from the gist of the invention.

What is claimed is:

1. A management device that is configured to manage a robot device, the management device comprising:
a memory configured to store instructions; and
one or more processors configured to execute the instructions to:
acquire identification information for identifying the user and time information on a time at which a vehicle having a user therein is scheduled to arrive at an arrival point, wherein the arrival point is point at which the vehicle is scheduled to arrive and the user is scheduled to exit; and
provide the robot device with instruction information including the identification information for causing the robot device to guide the user from the arrival point to a destination of the user on the basis of the acquired time information and the acquired identification information.

2. The management device according to claim 1,
wherein the destination is located at a position which is in a predetermined facility and which the vehicle is not able to reach from the arrival point.

3. The management device according to claim 1, wherein the identification information is an image which is obtained by imaging the user or feature information indicating a feature which is extracted from the image.

4. The management device according to claim 1, wherein the instruction information includes an instruction for causing the robot device to wait at a set point which is set in advance at the arrival point or in a facility associated with the arrival point and the scheduled arrival time and to guide the user to the destination after the user has arrived at the arrival point.

5. The management device according to claim 1,
wherein the robot device that is configured to wait at a set point which is set in advance in a facility associated with the arrival point, and
wherein the instructions further comprise instructions to provide a terminal device correlated with the user with information indicating a route from the arrival point to the set point.

6. The management device according to claim 1,
wherein the instructions further comprise instructions to:
provide a terminal device correlated with the user with information indicating a route from the arrival point to a set point which is set in advance in a facility associated with the arrival point and at which the robot device waits when a distance from the arrival point to the set point is equal to or greater than a predetermined distance.

7. The management device according to claim 1,
wherein the instructions further comprise instructions to:
determine whether the user has used a facility including the destination in the past with reference to information indicating whether the user has used the facility and determine a mode for inquiring of the user about whether to request the robot device guide the user to the destination via the vehicle or a terminal device carried by the user on the basis of the result of determination.

8. The management device according to claim 1,
wherein the instructions further comprise instructions to:
determine a route along which the robot device guides the user on the basis of positions of a plurality of destinations which are included in a predetermined facility or degrees of congestion of the destinations when the destination of the user includes the plurality of destinations.

9. The management device according to claim 1,
wherein the instructions further comprise instructions to:
determine a route along which the robot device guides the user on the basis of positions of a plurality of destinations which are included in a predetermined facility and degrees of congestion of the destinations when the destination of the user includes the plurality of destinations.

10. A management system comprising:
the management device according to claim 1; and
a robot device that is configured to guide the user to the destination on the basis of the instruction information provided by the management device.

11. A management system comprising:
the management device according to claim 1; and
a vehicle which the user boards,
wherein the management device is configured to acquire the time information and the identification information from the vehicle.

12. The management system according to claim 11, further comprising a robot device that is configured to guide the user to the destination on the basis of the instruction information provided by the management device.

13. A management device that is configured to manage a robot device, the management device comprising:
a memory configured to store instructions; and
one or more processors configured to execute the instructions to:
acquire identification information for identifying the user and time information on a time at which a vehicle having a user therein is scheduled to arrive at an arrival point, wherein the arrival point is point at which the vehicle is scheduled to arrive and the user is scheduled to exit; and
provide the terminal device correlated with the user with a route from the arrival point to a point at which the robot device waits on the basis of the acquired time information and the acquired identification information and provide the robot device with instruction information including the identification information for causing the robot device to guide the user from the point at which the robot device waits to a destination of the user.

14. A management method of managing a robot device, which is performed by a computer, the management method comprising:
acquiring identification information for identifying the user and time information on a time at which a vehicle having a user therein is scheduled to arrive at an arrival point at which the vehicle is scheduled to arrive and the user is scheduled to exit; and
providing the robot device with instruction information including the identification information for causing the robot device to guide the user from the arrival point to a destination of the user on the basis of the acquired time information and the acquired identification information.
